(19) United States
(12) Patent Application Publication
(10) Pub. No.: US 2013/0236655 A1
(43) Pub. Date: Sep. 12, 2013

(54) PHOTO-SENSITIVE ELECTROMAGNETIC-WAVE INTERCEPTION INK COMPOSITION, ELECTROMAGNETIC-WAVE INTERCEPTION CURED MATERIAL, AND MANUFACTURING METHOD OF ELECTROMAGNETIC-WAVE INTERCEPTION CURED MATERIAL

(71) Applicant: PANASONIC CORPORATION, Osaka (JP)

(72) Inventors: Shogo NASU, Hyogo (JP); Eiichi URIU, Osaka (JP); Hisayo OHATA, Osaka (JP)

(73) Assignee: Panasonic Corporation, Osaka (JP)

(21) Appl. No.: 13/869,203

(22) Filed: Apr. 24, 2013

Related U.S. Application Data
(63) Continuation of application No. PCT/JP2012/002837, filed on Apr. 25, 2012.

(30) Foreign Application Priority Data
Jul. 29, 2011 (JP) 2011-166880

(51) Int. Cl. C09D 5/32; C09D 5/33

(52) U.S. Cl. CPC C09D 5/32; C09D 5/004
USPC 427/511; 252/519.2; 252/519.21; 427/559

(57) ABSTRACT

A photosensitive electromagnetic-wave interception ink composition containing a photosensitive metal complex, electrically conductive particles, soft magnetic particles and a solvent is used for forming a coated film on a surface of a particular circuit element mounted on a circuit board by an ink-jet method, and the film is irradiated with light, whereby an electrically conductive cured material 100 containing at least electrically conductive particles 120 originated from the photosensitive electromagnetic-wave interception ink composition and the soft particles 140 is formed.

### CROSS REFERENCE TO RELATED APPLICATIONS

This is a continuation application of PCT Application No. PCT/JP2012/002837, filed on Apr. 25, 2012, designating the United States of America, which claims the priority of Japanese Patent Application No. 2011-166880 filed on Jul. 29, 2011, the disclosure of which, including the specifications, drawings, and claims, are incorporated herein by reference in their entireties.

### BACKGROUND OF THE INVENTION

The present disclosure relates to an electromagnetic-wave interception ink composition, an electromagnetic-wave interception cured material, and a manufacturing method of electromagnetic-wave interception cured material, which are used for suppressing electromagnetic interference caused by unnecessary interference of electromagnetic waves in electronic equipment.

There are problems of electromagnetic noise generated from electronic equipment such as mobile telecommunications and medical equipment, and home appliance. The “electromagnetic noise” refers to unnecessary signals passing through an electronic circuit, which are due to unnecessary electromagnetic wave emitted from the electronic equipment and so on. There is possibility that electromagnetic noise may cause failure such as malfunction of equipment. As a higher frequency and higher integration are employed in an electronic circuit board, the electromagnetic wave generated from one circuit element in an electronic device may generate electromagnetic noise in another circuit element in the electronic device, resulting in failure of the device. The similar phenomenon may be observed in a plurality of circuit boards in one single electronic device.

In order to avoid the above-described failure, an electromagnetic-wave absorption and/or electromagnetic-wave reflection (or shield) material is employed in the electronic equipment for eliminating or reducing effects of the electromagnetic wave. The electromagnetic absorption and/or reflection material is provided in a form of, for example, sheet, and is used such that they cover, for example, a part of or the entire of the circuit board. Alternatively, in JP-A-2008-85057, it is suggested that the electromagnetic absorption and/or reflection material in paste form is applied so as to cover a desired component.

### SUMMARY OF THE INVENTION

The electromagnetic absorption and/or electromagnetic reflection material in the form of sheet is cut into an appropriate size depending on, for example, shape and size of a circuit element, and then stuck to the circuit component mounted on a circuit board to cover the component. Such cutting is burdensome. Further, the covering with the sheet tends to generate space between the sheet and the circuit board, whereby the electromagnetic wave may advance through the space to cause the failure due to the electromagnetic noise.

The paste-like electromagnetic-wave absorption and/or electromagnetic-wave reflection material in paste form, as described in JP-A-2008-85057 is usually used by being applied to a predetermined site with a device such as a dispenser. Thus, the covering operation using the past material is easier and is less likely to generate the space between the circuit board and the electromagnetic-wave absorption and/or electromagnetic-wave reflection material after covering, compared to the covering operation using the sheet material. However, the content of soft magnetic particles and the resin content are required to be increased in the electromagnetic-wave absorption and/or electromagnetic-wave reflection material in paste form for improving the electromagnetic-wave absorption property, and the resin content is required to be increased. For this reason, a viscosity of the past is high. It is difficult to apply the material of high viscosity only to a particular small circuit element. Further, the electromagnetic-wave absorption and/or electromagnetic reflection material of high viscosity tends to be thick after the covering, giving a thickness of several millimeters or more, for example. When a thick film is disposed on a surface of the circuit element, heat generated from the circuit element cannot be released to the outside, resulting in deterioration of the circuit element due to heat.

The present disclosure provides an electromagnetic-wave interception material which enables a composition having both electromagnetic-wave shielding property and electromagnetic-wave absorption property to cover only a particular circuit element on a circuit board, enables heat generated from the circuit element to be released to the outside, and can cover the circuit element by an easier process compared to the conventional material.

The present inventors have intensively studied and found that only a predetermined circuit element can be covered with an electromagnetic-wave interception material by applying a printing method using an ink-jet method. Further, they found that the circuit element can be covered with the electromagnetic-wave interception material by an easier process when an ink composition containing the electromagnetic-wave interception material is made photosensitive.

The present disclosure provides a photosensitive electromagnetic-wave interception ink composition containing a photosensitive metal complex, electrically conductive particles, soft magnetic particles, a resin and a solvent. In the present specification, the term “electromagnetic-wave interception” means properties of absorbing and/or reflecting electromagnetic wave. Further, the term “photosensitive” means that nature of the material is changed by being irradiated with light.

The present disclosure provides an electromagnetic-wave interception cured material containing at least electrically conductive particles and soft magnetic particles. The electromagnetic-wave interception cured material can prevent the electromagnetic wave from reaching an object or reduces the electromagnetic wave which reaches the object due to the material properties of absorbing and/or reflecting the electromagnetic wave, when the material is disposed on a surface of the object

This electromagnetic-wave interception cured material is formed by a method that includes: discharging the photosensitive electromagnetic-wave interception ink composition of the present disclosure toward a circuit board by the ink-jet method so as to form a coated film which covers one or more objects mounted on the circuit board; and irradiating the coated film with light.

The photosensitive electromagnetic-wave interception ink composition of the present disclosure can form, by an ink-jet method, a coated film which intimately covers only one or more circuit elements which are object(s) on which the electromagnetic wave is to be prevented from arriving, along with the shape of the element(s), resulting in no space between the coated film and the surface of the circuit board around the circuit element(s). This coated film is cured by irradiation of light to give an electromagnetic-wave interception cured material in a form of film, and the film contains at least electrically conductive particles and soft magnetic particles wherein the electrically conductive particles impart high electrical conductivity and thermal conductivity to the film. For this reason, this electromagnetic-wave interception cured material can favorably release heat generated from the circuit element to the outside.

Thus, the photosensitive electromagnetic-wave interception ink composition of the present disclosure favorably protects the circuit element from electromagnetic wave, enabling the reduction in failure due to electromagnetic noise, and releases the heat generated from the circuit element to the outside. Further, the photosensitive electromagnetic-wave interception ink composition of the present disclosure forms an electromagnetic-wave interception cured material in a form of film by an ink-jet method and light irradiation, enabling only the circuit element, which is an object, to be protected from electromagnetic wave with ease.

### BRIEF DESCRIPTION OF THE DRAWINGS

FIG. 1 is a cross-sectional view which schematically shows an electromagnetic-wave interception cured material of the present disclosure.

FIG. 2 is a side elevational view which schematically shows a method for forming an electromagnetic-wave interception cured material of the present disclosure.

FIG. 3 is a flow diagram which shows an embodiment of a method for forming an electromagnetic-wave interception cured material of the present disclosure.

### DETAILED DESCRIPTION OF THE PREFERRED EMBODIMENTS

The photosensitive electromagnetic-wave interception ink composition of the present disclosure (which may be called merely “ink composition” hereinafter) contains at least a photosensitive metal complex, electrically conductive particles, soft magnetic particles, a resin and a solvent, and further contains a dispersant and a surface tension regulator in general. These components are described bellow.

(Photosensitive Metal Complex)

A photosensitive metal complex is a compound wherein ligands are coordinated to a metal which is a center and has photosensitivity. The decomposition and so on of the ligands occurs in the photosensitive metal complex by light irradiation, whereby the photosensitive metal complex gives electrically conductive particles after light irradiation. Further, the photosensitive metal complex serves to bind the electrically conductive particles formed from this complex, and electrically conductive particles which are previously included in the ink composition, to cure the ink composition giving a hard film. The electrically conductive particles are, for example, metal particles or metal oxide particles.

Specifically, the photosensitive metal complex gives, by light irradiation, particles of nonmagnetic metal such as aluminum, copper, silver, indium, magnesium, tantalum, or zinc, or particles of metal oxide, such as indium-tin oxide, tin oxide, antimony tin oxide, zinc oxide, or aluminum zinc oxide. The photosensitive metal complex may give one type or two or more types of electrically conductive particles. Alternatively, the ink may contain only one type of photosensitive metal complex, or two or more types of photosensitive metal complexes.

The photosensitive metal complex may be an acetylacetone complex wherein acetylacetonato is coordinated to a center metal which is selected from aluminum, copper, silver, indium, magnesium, tantalum and zinc. Alternatively, the photosensitive metal complex may be a complex wherein another β-diketone is coordinated. β-diketones include benzoylacetone, benzoyltrifluoroacetone, benzoyldifluoroacetone, and benzoylfluoroacetone and so on.

Alternatively, the photosensitive metal complex may be a metal complex wherein an organic amine is coordinated to a metal. In this case, the organic amines which form a complex together with the metal include, for example, ethylamine, methylamine, butylamine, and triethanolamine and so on.

The photosensitive metal complex is preferably dissoluble in an organic solvent which is contained in the ink composition. When the photosensitive metal complex is dissolved in the organic solvent contained in the ink composition, the stability of the ink composition becomes favorable.

It is preferable that the photosensitive metal complex gives the electrically conductive particles of which particle diameter is in a range of 10 nm to 300 nm, by being irradiated with light. In particular, it is preferable that the photosensitive material complex gives the electrically conductive particles of which particle diameter is in a range of 10 nm to 200 nm, in view of the mechanical strength and density of the cured material which is formed by forming the coated film from the ink composition followed by irradiating the film with light and then drying the film if necessary. Here, the particle diameter is an average primary particle diameter of the metal particle and the oxide particle which is determined by a laser diffraction method and refers to a median diameter D50 of determined particle size distribution.

In the ink composition, the photosensitive metal complex is preferably contained in an amount of 5 parts to 50 parts by weight, more preferably 10 parts to 40 parts by weight in the ink composition, assuming that the total amount of the photosensitive metal complex and the below-described soft magnetic particles and electrically conductive particles is 100 parts by weight. The photosensitive metal complex gives the electrically conductive particles and binds the electrically conductive particles in the electromagnetic-wave interception cured material (which is merely called “cured material” hereinafter) which is formed by light irradiation. The electrically conductive particles which are formed from the photosensitive metal complex serve to reflect the electromagnetic wave in the cured material and to confer electrical conductivity to the cured material. Therefore, if the proportion of the photosensitive metal complex is too small in the ink composition, the bonding between the electrically conductive particles may be insufficient and/or the electrical conductivity of the cured material may be low. On the other hand, if the proportion of the photosensitive metal complex is too large, the proportions of the other components are small such that the ink composition suitable for forming the coated film by the ink-jet method may not be obtained or the electromagnetic-wave interception effect of the soft magnetic particles may not be exerted sufficiently.

(Electrically Conductive Particle)

An electrically conductive particle is used for imparting electrically conductivity to the cured material. The electrically conductive particles are formed from the photosensitive metal complex, as described above, but sufficient electrical conductivity cannot be achieved only by the electrically conductive particles formed from the photosensitive metal complex. For this reason, the ink composition of the present disclosure contains electrically conductive particles previously. The electrically conductive particles are, for example, metal particles or metal oxide particles. Specifically, the electrically conductive particles are particles of nonmagnetic metal such as aluminum, copper, silver, indium, magnesium, tantalum, or zinc or the like, or particles of metal oxide such as indium tin oxide, tin oxide, antimony tin oxide, zinc oxide, or aluminum zinc oxide. Two or more types of electrically conductive particles may be contained. Further, the electrically conductive particles may be the same as or different from the electrically conductive particles formed by irradiating the photosensitive metal complex with light.

The electrically conductive particles previously contained in the ink composition preferably have a particle diameter in a range of 10 nm to 300 nm. The electrically conductive particles having a particle diameter within such a range are suitable for forming the coated film by an ink-jet method, and easy to bind together upon applying light to the ink composition of the present disclosure, facilitating the formation of electrically conductive film.

The electrically conductive particles are preferably contained in an amount of 5 parts to 40 parts by weight, more preferably 10 parts to 30 parts by weight in the ink composition, assuming that the total amount of the photosensitive metal complex, and the below-described soft magnetic particles and the electrically conductive particles is 100 parts by weight. The electrically conductive particles serve to reflect the electromagnetic wave in the cured material and to impart electrical conductivity to the cured material. Therefore, if the proportion of the electrically conductive particles is too small in the ink composition, the electrical conductivity is low. On the other hand, if the proportion of the electrically conductive particles is too large, the proportions of the other components are small such that the ink composition suitable for forming the coated film by the ink-jet method may not be obtained or the electromagnetic-wave interception effect of the soft magnetic particles may not be exerted sufficiently.

(Soft Magnetic Particle)

Soft magnetic particle is a particle of metal, an alloy or an metal oxide, which presents soft magnetism. Specifically, the soft magnetic particles include particles of metals such as Fe, Co and Ni, particles of magnetic alloys such as FeNi and CoNbZr, particles of oxides such as iron oxide, NiZn ferrite, MnZn ferrite, Ba ferrite, and z-type hexagonal ferrite and so on. The material for the soft magnetic particles is selected such that a high imaginary part (μ″) is obtained in a complex magnetic permeability in a predetermined frequency band.

The particle diameter of the soft magnetic particles is preferably in a range of 5 nm to 5 μm. As the particle diameter of the soft magnetic particles is smeller, the soft magnetic particles present higher soft magnetism in a high frequency characteristic. However, if the particle diameter is less than 5 nm, the magnetic characteristic may be significantly deteriorated, resulting in reduction in the electromagnetic-wave noise elimination effect of the cured material. On the other hand, if the particle diameter is over 5 μm, the mechanical characteristic of the cured material as the coated film may be deteriorated. The shape of the particle is desirably sphere since the incident angle dependence of the electromagnetic noise is small. However, the shape of the soft magnetic particles is not limited to this, and may be flattened.

The soft magnetic particles are preferably contained in an amount of 20 parts to 80 parts by weight, more preferably 30 parts to 70 parts by weight in the ink composition, assuming that the total amount of the photosensitive metal complex, the soft magnetic particles and the electrically conductive particles is 100 parts by weight. If the proportion of the soft magnetic particles is too small, the electromagnetic noise elimination effect of the cured material is decreased. On the other hand, the proportion of the soft magnetic particles is too large, the proportions of the other components may be small such that the ink composition suitable for forming the coated film by the ink-jet method may not be obtained or sufficient electrically conductivity may not be obtained.

(Resin)

The ink composition of the present disclosure contains a resin for the purpose of adjustment of viscosity of the ink composition, suppression of precipitation, and adjustment of viscoelasticity. As the resin, one or more resins which are selected from a cellulose-based resin, an olefin-based resin, a polyvinyl chloride resin, an acrylic rein, an acrylate resin, a polyurethane resin, a polycarbonate resin, a polyester resin, an alkyd resin, a polystyrene resin, a polyacetal resin, a polyamide resin, a polyvinyl alcohol resin, a polyvinyl acetate, and an epoxy resin, are used. The cellulose-based resins are preferably ethyl cellulose and methyl cellulose. A weight-average molecular weight (which is indicated as “Mw” hereinafter) of the resin is preferably in a range of 10,000 to 200,000.

The resin constituting the ink composition of the present disclosure is preferably one which exists in the cured material in an amount as small as possible, so that the cured material, which is formed by irradiating the ink composition with light and then optionally subjecting the composition to thermal treatment for drying, has high electrical conductivity. In other words, the resin preferably decomposes by catalytic action caused by the light irradiation and the heat treatment on the surface of the metal particles and/or decomposes or evaporates by light or heat, whereby the resin does not remain in the cured material. Such resin is, for example, one having low-temperature decomposability, low-temperature sublimability, low melting point and/or low boiling point, and generally has a low molecular weight. Specifically, cellulose-based resin, olefin-based resin and polyvinyl chloride resin are preferably used as the resin having such characteristics.

The resin is preferably contained in an amount of 0.1 parts to 10 parts by weight, more preferably 0.5 parts to 5 parts in the ink composition by weight assuming that the total amount of the photosensitive metal complex and the soft magnetic particles and the electrically conductive particles is 100 parts by weight. The ink composition containing the resin in an amount of such range has viscosity and viscoelasticity suitable for forming the coated film by the ink-jet method, and is less likely to show precipitation of components.

(Solvent)

In the ink composition of the present disclosure, the solvent ensures the fluidity (that is, the viscosity) of the ink composition and serves as a dispersion medium for dispersing components uniformly. The solvent is selected from, for example, water, an aromatic solvent, an aliphatic solvent, a ketone-based solvent, an ether-based solvent, an ester-based solvent, an alcohol-based solvent, and a glycol ether-based solvent and so on. The solvent may be used alone or a mixture of two or more solvents may be used.

The aromatic solvents are, for example, butyl carbitol acetate, terpineol, toluene and xylene. The aliphatic solvents are, for example, hexane and heptane. The ketone-based solvents are, for example, acetone, methyl ethyl ketone, diethylketone, methylisobutylketone and cyclohexanone. The ether-based solvents are, for example, dibutyl ether, dioxane and tetrahydrofuran. The ester-based solvents are, for example, ethyl acetate and butyl acetate. The alcohol-based solvents are, for example, methanol, ethanol and isopropyl alcohol. The glycol ether-based solvents are, for example, ethylene glycol monomethyl ether, diethylene glycol monomethyl ether, diethylene glycol monoethyl ether, diethylene glycol diethyl ether and butyl cellosolve.

The solvent is preferably contained in an amount of 30 parts to 90 parts by weight, more preferably 40 parts to 80 parts by weight in the ink composition, assuming that the total amount of the photosensitive metal complex, the soft magnetic particles and the electrically conductive particles is 100 parts by weight. The ink composition containing the solvent in an amount of such a range has fluidity suitable for being discharged from a nozzle in the ink-jet method.

(Dispersant (Surfactant))

The ink composition of the present disclosure may optionally contain a dispersant for improving dispersibility of the soft magnetic particles and the other components. The dispersant may be a surfactant.

As the dispersant, one or more substances selected from, for example, acrylic copolymers, alkyl ammonium salts, siloxanes, polyvinyl alcohols and polyoxyethylene alkyl ethers, may be used.

Alternatively, as the dispersant, an anionic surfactant, a nonionic surfactant, or an amphoteric surfactant may be used. The anionic surfactants include, for example, styrene-acrylic acid copolymer, styrene-maleic acid copolymer, styrene-methacrylic acid copolymer, styrene-acrylic acid-acrylate copolymer, styrene-methacrylic acid-acrylate copolymer, alkyl sulfate salt, alkylallyl sulfate salt, alkylnaphthalene sulfate salt, naphthalene sulfonic acid formaldehyde condensate, polyoxyethylene alkylphosphate, and polyoxytethylene alkylether sulfate. The nonionic surfactants include, for example, polyoxyethylene alkyl ether, polyoxyethylene alkylallyl ether, polyoxyethylene sorbitol aliphatic acid ester, and acetylene glycol ethylene oxide adduct. The amphoteric surfactants include, for example, alkylbetaine, and alkylamine oxide.

The dispersant is preferably contained in an amount of 0.001 parts to 0.2 parts by weight, more preferably 0.005 parts to 0.1 parts by weight in the ink composition, assuming that the total amount of the photosensitive metal complex and the soft magnetic particles and the electrically conductive particles is 100 parts by weight. The ink composition containing the dispersant in an amount of such a range is one in which the components are dispersed stably.

(Surface Tension Regulator)

The ink composition of the present disclosure may further contain a surface tension regulator (a leveling agent). As the surface tension regulators, any of an anionic surfactant, a cationic surfactant, and an amphoteric surfactant may be used. Specifically, as the anionic surfactant, polyethylene glycol alkyl ether sulfate salt may be used. As the cationic surfactant, a poly-2-vinylpiridine derivative and a poly-4-vinylpiridine derivative may be used.

The surface tension regulator is preferably contained in an amount of 0.001 parts to 0.1 parts by weight in the ink composition, more preferably 0.002 parts to 0.05 parts by weight assuming that the total amount of the photosensitive metal complex and the soft magnetic particles and electrically conductive particles is 100 parts by weight. The ink composition containing the surface tension regulator in an amount of such a range appropriately spreads on a surface of a circuit element which is an object to be coated and a surface of a circuit board around the element, covering the entire circuit element.

(Method for Forming a Cured Material)

The ink composition containing the above-described components forms a coated film when being discharged toward an object by an ink-jet method. The coated film is cured by being exposed to light, forming an electromagnetic-wave interception cured material of the present disclosure. Hereinafter, a method for forming the cured material is described with reference to FIG. 1.

An ink-jet printing (or recording) apparatus for conducting the ink-jet method is provided with a head 14 wherein a plurality of nozzles that discharge the ink composition 10 are disposed, a support table (not shown) on which a circuit board 19 with a circuit element 16 that is an object where a coated film 12 is formed, is to be placed, and a detection device (not shown) , such as a camera, for detecting the position of the circuit board 18 and the application position of the ink composition 10. The ink-jet printing apparatus is configured such that relative position between the nozzles of the head 14 and the circuit board 18 can be changed depending on the detection results of the detection device. After confirming the positions, the ink-jet printing device discharges the droplet ink composition 10 toward a previously designated location, forming the coated film 12. At this point, a thickness of the coated film 12 (a thickness at the thickest point) is preferably in a range of 1 μm to 5 μm in view of the electromagnetic-noise reduction effect of the cured material and the strength of the cured material.

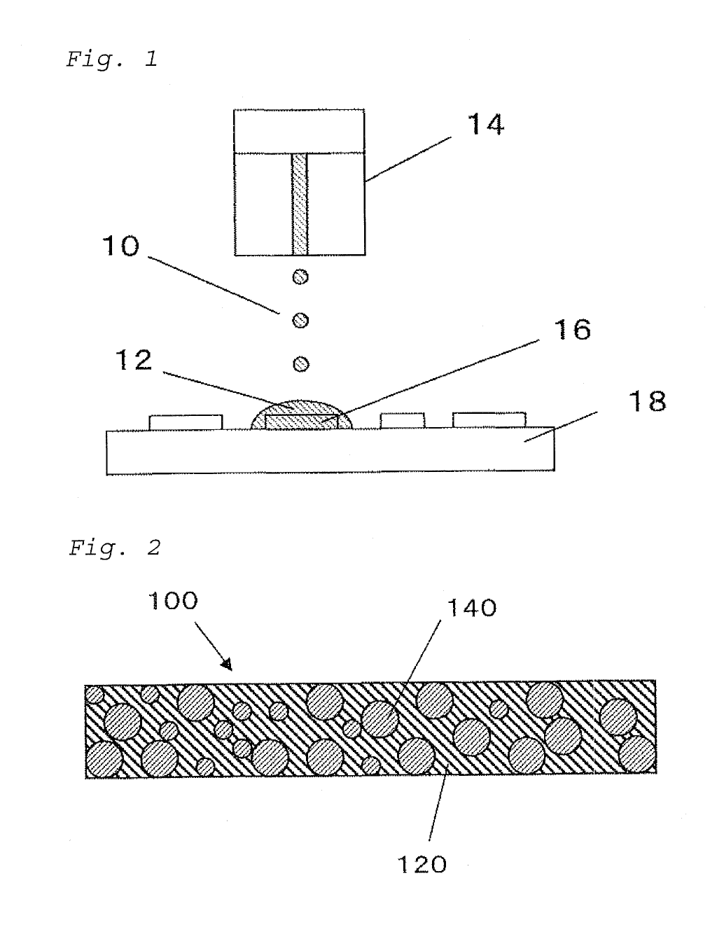

Next, the coated film is cured by irradiating the coated film with light. The irradiation of light is conducted using, for example, an ultraviolet irradiation apparatus. The light irradiation may be conducted at room temperature. The photosensitive metal complex is changed in its nature by the light irradiation to give electrically conductive particles. Further, the electrically conductive particles formed from the photosensitive metal complex and electrically conductive particles previously contained in the ink composition are hardened by sintering to form a hard film. A cross-section of the cured material is schematically shown in FIG. 2. Soft magnetic particles 140 are dispersed in the film cured material 100 formed of the sintered body 120 of the electrically conductive particles. The cured material 100 preferably has a thickness (a thickness at the thickest point) of 1 μm to 3 μm.

Thermal treatment may be conducted before or after the light irradiation. The thermal treatment is carried out in order to decompose or evaporate the resin contained in the ink composition, and/or to evaporate the solvent contained in the ink composition. The thermal treatment may be conducted in air at a temperature of, for example, 70° C. to 200° C.

When the coated film is formed by the ink-jet method, a viscosity of the ink composition at 25° C. (which is called merely “viscosity” hereinafter) is preferably 10 mPa·s or more and 40 mPa·s or less. The viscosity of this range can be achieved when the total contents of the photosensitive metal complex, the electrically conductive particles, the soft magnetic particles and the resin is 40% to 70% by weight and the molecular weight and the content of the resin are optimally adjusted. When the viscosity of the ink composition is less than 10 mPa·s, the solid in the composition rapidly precipitates, resulting in the precipitation and agglomeration of the respective particles in the ink-jet apparatus. As a result, the concentrations (contents) of the solid in the respective droplets discharged from apertures of nozzles in the ink-jet head cannot be kept constant and vary, which leads to uneven thickness and uneven composition of the coated film, resulting in deterioration of the resultant cured material. On the other hand, when the viscosity is over 40 mPa·s, the ink composition is difficult to discharge from the aperture of the nozzle in the ink-jet head.

Further, the surface tension of the ink composition is preferably in a range of 15 mN/m to 50 mN/m. When the surface tension is not in this range, stable droplets may not be formed or spatter may occur.

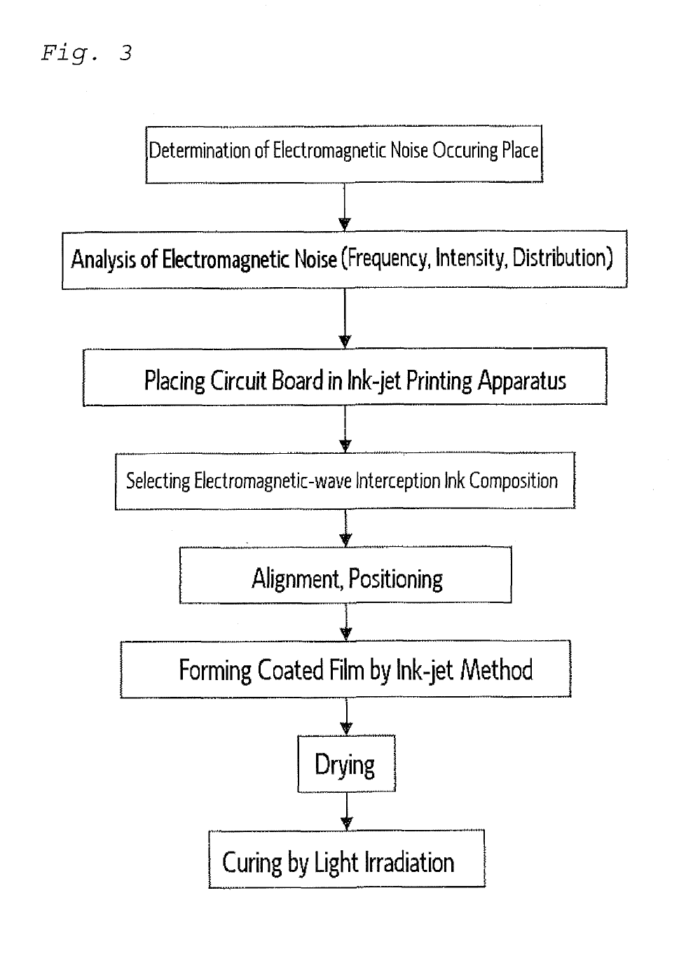

The ink-jet method enables the cured material to cover only a single circuit element mounted on a circuit board, or the circuit elements which are placed away from each other, respectively. This is because the ink-jet method makes it possible to spray a fine droplet accurately onto a predetermined position to form a coated film having a small area. Thus, the ink-jet apparatus may be combined with a device for detecting or forecasting positions where electromagnetic noise occurs, and a device for analyzing a frequency, strength and distribution of the electromagnetic wave that is cause of the electromagnetic noise, and the cured material may be formed according to the procedures shown in FIG. 3.

(Cured Material)

A cured material of the present disclosure, which is formed using the ink composition of the present disclosure, contains at least electrically conductive particles and soft magnetic particles. The electrically conductive particles contained in the cured material are, in addition to ones which have previously existed in the ink composition, ones formed by irradiating the photosensitive metal complex with light. In the cured material, the electrically conductive particles are bound, to form an electrically conductive film. It is considered that the binding of the electrically conductive particles is due to catalytic reaction caused by light, in which the photosensitive metal complex is involved. The electrically conductive particles impart the electrical conductivity and the thermal conductivity to the cured material, and serve to intercept the electromagnetic wave by reflecting the same.

In the cured material, the electrically conductive particles are preferably contained in an amount of 30% to 80% by weight, more preferably 40% to 80% by weight assuming that the total amount of the electrically conductive particles and the soft magnetic particles is 100% by weight. The cured material containing the electrically conductive particles in an amount of this range is excellent in electrical conductivity and thermal conductivity. The preferable particle diameter of the electrically conductive particles is as described in connection with the photosensitive metal complex and the electrically conductive particles previously contained in the ink composition.

In the cured material, the soft magnetic particles are dispersed in the film constituted by the electrically conductive particles. The soft magnetic particles serve to absorb the electromagnetic wave. The soft magnetic particles are preferably contained in an amount of 70% to 20% by weight, more preferably 60% by weight to 30% by weight in the cured material. The cured material containing the soft magnetic particles in an amount of this range present is excellent in electromagnetic-wave interception and thereby suppresses the electromagnetic noise.

The cured material is formed by irradiating the ink composition with light, and then optionally heating the ink composition. The resin is preferably removed from the cured material by decomposition during the light irradiation and the heating. It is, however, difficult to remove the resin completely. Thus, the cured material may contain the resin which has not been removed. In this case, the resin is preferably contained in an amount of 2 parts or less by weight, more preferably 0.5 parts or less by weight in the cured material, assuming that the total amount of the electrically conductive particles and the soft magnetic particles is 100 parts by weight. When the content of the resin is large, the electrically conductivity of the cured material is lowered.

The cured material is preferably formed such that its resistivity is 1×10⁻⁵ Ω·cm or less. It is necessary to determine the proportions of the electrically conductive particles and the soft magnetic particles in the cured material and to adjust the content of the resin which remains in the cured material so that such resistivity is achieved. The content of the resin in the cured material can be adjusted by the content of the resin in the ink composition, the light irradiation conditions and the conditions of the optional thermal treatment and so on.

A circuit element, which is an object for electromagnetic-wave interception, may be covered with an insulating coated film of an insulating resin and the cured material of the present disclosure may be formed on the insulating coated film. This is because direct coating of the cured material of the present disclosure onto the circuit element may not be appropriate in the case where the circuit element is required to be insulated from the outside. The insulating coated film may be formed by the ink-jet method. Thus, a coated film of double-layer structure is obtained by preparing an ink-jet head for forming the insulating coated film and an ink-jet head for forming the cured material and performing a plurality of film formations according to the ink-jet method. The insulating coated film is preferably one formed by curing a light-curable resin by light. The use of the light-curable resin makes it possible to form the cured material of the present disclosure and the insulating coated film by light irradiation simultaneously.

The cured material of the present disclosure can be formed using the ink-jet method, and can coat objects of various sizes. Therefore, the cured material of the present disclosure may be one for covering wire on a circuit board. Alternatively, the cured material of the present disclosure may cover another electronic component which is larger than a circuit element. Alternatively, the cured material of the present disclosure may be used for covering the entire surface of the circuit board.

The ink composition of the present disclosure enables a coated film to be formed by the ink-jet method. Thus, the cured material which is formed by using the ink composition is useful as an electromagnetic-wave interception film which covers a selected particular circular element or the like in various electronic components and electronic equipment.

What is claimed is:

1. A photosensitive electromagnetic-wave interception ink composition comprising a photosensitive metal complex, electrically conductive particles, soft magnetic particles, and a solvent.

2. The photosensitive electromagnetic-wave interception ink composition according to claim 1, which comprises a resin.

3. The photosensitive electromagnetic-wave interception ink composition according to claim 1, which further comprises a dispersant and a surface tension regulator.

4. An electromagnetic-wave interception cured material formed from a photosensitive electromagnetic-wave interception ink composition comprising a photosensitive metal complex, electrically conductive particles, soft magnetic particles, and a solvent.

5. The electromagnetic-wave interception cured material according to claim 4, wherein the photosensitive electromagnetic-wave interception ink composition further comprises a resin.

6. The electromagnetic-wave interception cured material according to claim 4, wherein the electrically conductive particles are bound to form a film.

7. The electromagnetic-wave interception cured material according to claim 4 further comprising a resin, wherein a content of the resin is 2 parts by weight or less assuming that the total amount of the electrically conductive particles and the soft magnetic particles is 100 parts by weight.

8. The electromagnetic-wave interception cured material according to claim 4, wherein the resistivity is 1×10⁻⁵ Ω·cm or less.

9. A method for producing an electromagnetic-wave interception cured material comprising:
discharging a photosensitive electromagnetic-wave interception ink composition comprising a photosensitive metal complex, electrically conductive particles, soft magnetic particles and a solvent, toward a circuit board by an ink-jet method so as to form a coated film which covers one or more objects mounted on the circuit board; and
irradiating the coated film with light.

10. The method for producing an electromagnetic-wave interception cured material according to claim 9, wherein the photosensitive electromagnetic-wave interception ink composition further comprises a resin.

11. The method for producing an electromagnetic-wave interception cured material according to claim 9, which further comprises heating the coated film.
